(19) United States
(12) Patent Application Publication
(10) Pub. No.: US 2003/0073414 A1
(43) Pub. Date: Apr. 17, 2003

(54) Textual and telephony dual input device

(76) Inventor: Stephen P. Capps, San Carlos, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/260,133

(22) Filed: Sep. 27, 2002

Related U.S. Application Data
(60) Provisional application No. 60/329,180, filed on Oct. 15, 2001.

(51) Int. Cl. H04B 1/38; H04M 1/00

(52) U.S. Cl. 455/90; 455/550; 455/575

(57) ABSTRACT

A device for receiving telephony and textual input has a display and a plurality of buttons labeled on different axes. The buttons are labeled for textual input on their horizontal axes (parallel to the long dimension of the device), and for telephony input on their vertical axes (parallel to the short dimension of the device). When held horizontally, the device allows entry of textual input, and functions as a textual communications device. When held vertically, the device allows entry of telephony input, and functions as a telephony device.

### CROSS-REFERENCE TO RELATED APPLICATIONS

This application claims priority under 35 U.S.C. §119(e) from U.S. Provisional Patent Application Serial No. 60/329,180, filed Oct. 15, 2001, the entirety of which is incorporated herein by reference.

### BACKGROUND

1. Field of Invention

The present invention relates generally to electronic communications devices, and more specifically to an electronic communications device that enables both textual and telephony input.

2. Background of Invention

Many devices are available today that combine multiple communication systems such as a phone system, an email system, a paging system, and an instant messaging system into a single device. For example, many cellular phones can send and receive text messages as well as phone calls. In order to send and receive phone calls, the device must have a way to accept telephony input. In order to send and receive text messages, the device must have a way to accept textual input. In general, telephony and textual input each have their own characteristics because they evolved separately and, as a result, function differently.

The history of telephony input in the form of the telephone keypad traces its ancestry approximately back one hundred years. In those days, a caller picked up the telephone receiver and asked an operator to place a call by either giving the recipient's name (“Mabel, can I talk to Marie”) or by giving the recipient's number (“Mabel, can I have MElrose-517”). With the advent of the rotary dial phone around 1920, however, the caller could dial a number and place the call herself, without the need for a human operator to connect the call. Although it took about 35 years for consumers to fully adopt rotary dialing, and for all of the central office equipment of the phone companies to be upgraded, by about the end of World War II, the rotary dial phone enjoyed widespread adoption among consumers.

During the reign of rotary dial, the concept of named exchanges, or local phone offices, was integral to the use of the telephone. Originally, phone companies assumed that telephone users couldn't remember a long sequence of numbers. Therefore, each neighborhood would have a local phone office whose named exchange was often chosen after a main street or a local landmark. This named exchange was an easily recognized memory aid for telephone users. For example, a phone number from that era may have been EMerson2-1397, which would represent the digits 362-1397.

With named exchanges, it was necessary to have letters on the telephone even though the name still simply represented a number. The rotary dial phone was designed with 10 holes, labeled 1 through 9 and 0. Of the 10 holes, eight contained letters. The number 1 hole had no letters (supposedly, it was assumed at the time that the number “1” might be confused with the letter “L”). The number “0” hole had no letters because it was reserved for dialing the telephone operator. Each of the remaining eight holes had three letters each, for example, the 2 hole had “ABC.” The letters and the numbers most often were set around the perimeter of the hole. This letter-number scheme enabled 24 of the 26 letters of the alphabet to be represented on the rotary dial phone. The letters “Q” and “Z” were omitted, supposedly to avoid confusion with the numbers 0 and 7. Therefore, certain named exchanges, such as “QUasar2-1397,” could not exist.

Named exchanges began to be phased out in the 1960s, but lingered on in some locales until as late as the 1970s. Even after named exchanges were no longer used, the same letter-number scheme was included on the rotary dial phone. The rotary dial phone was gradually replaced by the touch-tone phone beginning in the 1960s. The same letter-number scheme was employed on the touch-tone phone as described above for the rotary dial phone. Sometimes the letters on the telephone keypad were used for so-called “vanity” phone numbers, such as 1-800-GOFEDEX (for calling Federal Express). Otherwise, the letters of the touch-tone phone largely remained unused.

One advantage of the telephone is that virtually everyone knows how to use it, because its interface has remained similar for a long time. People are so accustomed to the telephone they have no desire or incentive to learn a new method of telephony input. Phone manufacturers have no incentive to change or update the telephone keypad because their customers do not want a change.

In recent years, however, two market trends have been chiefly responsible for the increasing use of the letters on the telephone's keypad as a means of textual input. The first market trend is the proliferation of “smart” telephones (both cellular and desk models) that contain a directory of names associated with telephone numbers. The second market trend is the increased popularity of telephone users sending and receiving text messages on smart telephones. The telephone keypad was designed for telephony input. Therefore, the use of the same keypad for textual input leads to numerous problems.

A smart telephone provides various laborsaving features. One of the most popular features of a smart telephone is its directory of names. To create a directory of names, the telephone user enters in telephone numbers and the names of individuals associated with each telephone number. This directory may then be used for popular features such as phone book dialing (like speed dialing) and caller-ID. With phone book dialing, the telephone user simply scrolls through her list of names, finds the desired name, and then utilizes the “call” button. With caller-ID, the telephone user sees not only the telephone number, but also the name of an incoming caller (if that caller is in the directory).

To take advantage of the features of a phone directory, a telephone user must enter textual data. A smart telephone requires a telephone user to enter in letters (textual input) in addition to numbers (telephony input). The telephone is designed for telephony input, however, and the letters on the telephone keypad simply are vestiges of the days of named exchanges, when letters used to represent numbers as a memory aid. Textual input on a telephone has two disadvantages. One disadvantage involves the keypad, and the second disadvantage involves the textual input itself.

The first disadvantage of textual input on a smart telephone is the requirement that the letter-number scheme that has existed on the telephone keypad since its inception be changed. To enter any name associated with a telephone number, a smart telephone must allow all 26 letters of the alphabet to be entered. The two letters normally missing on the telephone keypad (“Q” and “Z”) had to be added back to the telephone keypad. To add in the two letters, the long-standing convention of associating each number with three letters had to be changed. The letter-number scheme of a smart telephone is: 1, 2(ABC), 3(DEF), 4(GHI), 5(JKL), 6(MNO), 7(PQRS), 8(TUV), 9(WXYZ), and 0. Now, six numbers have three letters associated with them, but two numbers (“7” and “9”) have four letters associated with them. To use a smart telephone, a user must learn a new letter-number scheme from that which has long existed on the telephone.

The second disadvantage of textual input on a smart telephone is that it requires the telephone user to “tap” the numbers on a telephone keypad in a difficult and inefficient method. Normally, to input a number, the telephone user simply “taps” that number button on the telephone keypad. Even in the days of named exchanges, the telephone user only input a number once because the letter equivalent was assumed. A smart telephone however, does not assume a letter equivalent; rather the telephone user must tap numbers on the telephone keypad multiple times to get the desired letter. The first tap on the number gets the first letter associated with that number, the second tap gets the second letter, the third tap gets the third letter, and the fourth tap gets the fourth letter (where a fourth letter exists). The taps cycle around so that the fifth tap on the number (or the fourth tap if there are only three letters) gets the first letter associated with that number again. For example, to enter a “Q,” the telephone user must tap the “7” number twice. To enter the name “SMITH,” the user must tap “77776444844.” This tapping method is not only inefficient, but it is also counter-intuitive to many telephone users.

The second market trend chiefly responsible for the use of textual input on a telephone is the increased popularity of using text messaging on a smart telephone. Cellular telephone users, especially in Europe, use their telephones to send short text messages, which are similar to email messages. These text messages are composed on the telephone keypad using the tap method described above or using a method known as T9® (currently described at http://www.t9.com). The tap method described above is even more inefficient when sending text messages, which are usually longer than a name to be entered in a phone directory. Spaces must be entered between words (the convention for a space is a “0”) and sometimes the user must “pause” between entering certain letters. For example, to send the text message, “See U at 6,” the telephone user must tap “77770333308802806.” In this example, the user must wait before entering the second “E” (as “33”) to prevent the interpretation of the “3333” as “D” (the fourth tap cycles around to the first letter, so “3333” would be “D”).

The T9® method is currently available from AOL, Inc. of Dulles, Va. The T9® method uses dictionary and word-frequency statistics to predict the most likely definition of the series of taps on the telephone keypad. For example, the T9® method decodes the telephone key sequence “43556” as “HELLO” rather than any of the hundreds of possible word permutations for that number sequence. However, this method is not complete because many number sequences are ambiguous. For instance, “4663” may decode into the two common words “HOME” or “GOOD.” Various smart telephone manufacturers employ different methods to allow the telephone user to choose between these different word alternatives. Because both the tap and the T9® methods of textual input are inefficient, counter-intuitive, and impractical, neither method has gained widespread acceptance among telephone users.

The standard history of textual input begins with the QWERTY keyboard, which has been in use for over a hundred years. The QWERTY layout was originally designed to increase the distance between common letters so the mechanical arms of early manual typewriters wouldn't collide and jam. Since typewriters achieved widespread acceptance among consumers a long time ago, this QWERTY layout has become the standard for textual input. Touch typing, or typing without looking at the keys on the keyboard, is dependent completely upon the QWERTY keyboard retaining the same spatial layout of the keys. Every once in a while alternatives such as the Dvorak keyboard or the Oliver “two-finger” keyboard have been introduced to the marketplace. However, people are so accustomed to the QWERTY keyboard that they have no desire or incentive to learn a new method of textual input. Mainstream keyboard manufacturers have no incentive to change or update the QWERTY keyboard because their customers do not want a change.

On portable textual communications devices, however, the size of the device does not permit a standard QWERTY keyboard. These devices generally employ a miniaturized and simplified QWERTY keyboard. One such device is the Blackberry Model 957, manufactured by Research In Motion of Waterloo, Canada. (currently described at http://www.rim.net/products/index.shtml). A simplified QWERTY keyboard contains only three rows of keys. The top row of the standard QWERTY keyboard containing the numbers and pun0ctuation was removed to accommodate the small size of the device. The missing number keys were overlaid upon the first row of letters on a simplified QWERTY keyboard. For example, “1” is overlaid on the “Q.” The missing punctuation marks were overlaid on the second and third rows of the simplified QWERTY keyboard. For example, “$” is overlaid on the “Z.” An “option” key was added underneath the “A.” The option key invokes the overlaid numbers and punctuation symbols. For example, to enter the equal sign (“=”), the user presses the option key and the “G.” Other standard QWERTY keys, such as the shift key, the delete key, the backspace key, and the carriage return key are also provided on the simplified QWERTY keyboard.

One advantage of a simplified QWERTY keyboard is that the letters are in the same spatial layout as in the standard QWERTY keyboard. Touch-typing is not possible on a simplified QWERTY keyboard because the keys are too small for fingertips; most often, the user enters textual data with her thumbs. This familiar letter layout does, however, facilitate “hunt and peck” thumb typing because any user of a standard QWERTY keyboard knows the location of each letter on the keyboard in relation to the other letters. For textual input, a simplified QWERTY keyboard is still not optimal, because the number and punctuation keys are in different locations than their locations on a QWERTY keyboard. But, textual input on a simplified QWERTY keyboard is easier than textual input using a smart telephone.

Telephony input with a simplified QWERTY keyboard is awkward for many reasons. First, the numbers are not in the same location or spatial relation to one another as the numbers are on the telephone keypad. Second, the numbers are not in the same location as the numbers on the standard QWERTY keyboard, instead they are overlaid on the first row of letters. Third, the option key often must be used in conjunction with the letter keys to enter a number. For example, to enter “1,” the user taps the option key and the “A.” A simplified QWERTY keyboard is not only awkward for entering telephony input, but it's also inefficient. For example, to enter in the telephone number “555-1397,” the user must tap the option key and then a number key a total of 14 times (i.e., “option” and “5,” “option” and “5,” “option” and “5,” “option” and “1,” etc.). Therefore, the user interface of a simplified QWERTY keyboard (its display and keys) is simply too unnatural and inefficient for telephony input.

The telephone keypad and the QWERTY keyboard were historically designed for completely different uses. The telephone keypad was designed for telephony input and the QWERTY keyboard was designed for textual input. Because people talked and typed at the same time, but never on the same device, the twain did not meet. New computing devices, however, now are available to consumers, which allow both telephony input and textual input on one device. Some devices, such as a smart telephone, have familiar, telephone-like interfaces for telephony input, but unnatural and inefficient interfaces for textual input. Other devices, such as the Blackberry, have familiar, QWERTY keyboard-like interfaces for textual input, but unnatural and inefficient interfaces for telephony input.

Contemporary portable communications devices are optimized for either telephony or textual input, and are difficult to use for both purposes. A telephone is optimized for telephony input because the telephone keypad was designed originally only for that purpose. Therefore, textual input on a smart telephone is unnatural, inefficient, and impractical. A portable communications device with a simplified keyboard, for example a simplified QWERTY keyboard, is optimized for textual input because the QWERTY keyboard was designed originally for that purpose only. Thus, telephony input on such a device is unnatural, inefficient, and impractical. For these reasons, most consumers find it easier to carry two devices, a smart telephone and a portable communications device with a keyboard, each of which is optimized for a different method of data entry, rather than to attempt to use one of these devices for both telephony and textual input.

Accordingly, there exists a need for a device which allows a familiar, natural, and efficient way to enter both telephony input and textual input.

### SUMMARY OF INVENTION

A device provides easy-to-use, natural, and efficient ways to enter both telephony input and textual input. Various embodiments of the present invention provide a single device that allows both telephony and textual input in ways that are familiar to users of smart telephones and portable textual communications devices. In some embodiments, a simplified QWERTY keyboard and a telephone keypad are overlaid on one set of buttons in two orientations. The information on the display is also presented in two orientations. The overlaid, rotated legends on the buttons of the keyboard, and the two orientations of the screen display of the device, solve the problems associated with inputting telephony and textual data on a single device. This novel, easier-to-use combination device permits rapid and fluent data entry in both telephony input mode and textual input mode on a single device.

One embodiment of the present invention comprises a device that resembles a smart telephone, with the addition of a sliding cover that partially covers the display of the device when the sliding cover is closed. When the sliding cover is closed, the device operates in telephony input mode. When the sliding cover is opened, the device operates in textual input mode.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIGS. 1a-1c are diagrams of a device shown in textual input mode, according to one embodiment of the present invention.

FIGS. 2a-2c are diagrams of a device shown in telephony input mode, according to one embodiment of the present invention.

FIGS. 3a-3c are diagrams of a device with hidden parts revealed shown in both textual and telephony input mode, according to one embodiment of the present invention.

FIGS. 4a-4b are diagrams of a device with its screen shown in both textual and telephony input mode, according to one embodiment of the present invention.

FIGS. 5a-5e are diagrams of devices according to another embodiment of the present invention.

FIGS. 6a-6c are diagrams of an enlarged cross sectional view of the pivoting area of a device according to another embodiment of the present invention.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

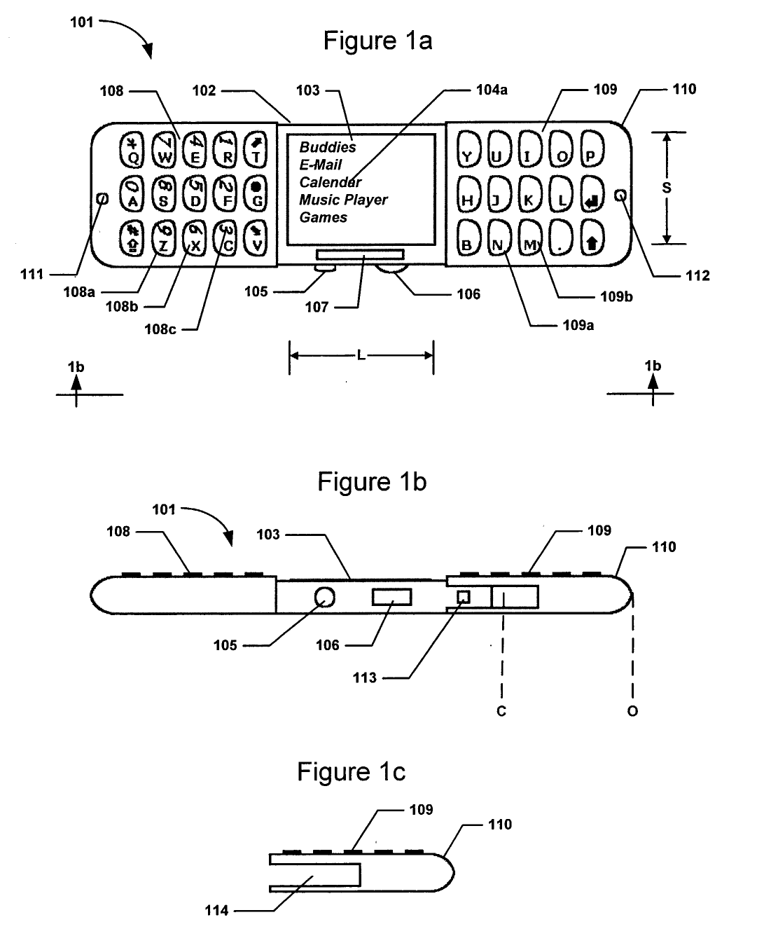

FIG. 1a is a top plan view of a portable device 101 in textual input mode, according to one embodiment of the present invention. The body of the device 102 has an LCD display 103 (or other display type), displaying lines of text 104a. The display 103 has a long dimension L and a short dimension S, where L is typically greater than S. The device 101 also has an escape button 105, a jog wheel 106 and a space bar 107. In some embodiments, the device 101 has more, fewer or similar input devices, as desired. The device 101 also has a simplified QWERTY keyboard divided into two portions, portions 108 and 109, containing buttons 108a and 109a. In other embodiments, keyboard layouts other than QWERTY can be used. Keyboard portion 108 is located on the left side of the device 101 and contains buttons 108a labeled with half (or about half) of the textual legends 108b of a simplified QWERTY keyboard. For example, the first row of the left portion 108 of the simplified QWERTY keyboard can contain buttons 108a labeled “QWERT.” The textual legends 108b are oriented to be parallel to the long dimension L of the device. The buttons 108a on portion 108 are also labeled with telephony legends 108c of a standard telephone keypad. The telephony legends 108c are oriented to be parallel to the short dimension S of the device. Keyboard portion 109 is located on a sliding cover 110 on the right side of the device 101 and contains buttons 109a labeled with the remaining textual legends 109b of a simplified QWERTY keyboard. For example, the first row of the right portion 109 of the simplified QWERTY keyboard can contain buttons 109a labeled “YUIOP.” The textual legends 109b are oriented to be parallel to the long dimension L of the device. The aperture for the microphone 111 is typically located on the left side of the device and the aperture for the earphone 112 is typically located on the sliding cover 110 on the right side of the device. In textual input mode, the information on the display 103 is formatted in “landscape” mode. In landscape mode, the lines of text 104a on the display 103 are parallel to the long dimension L of the display 103.

The jog wheel 106 (or similar input device) can be used to scroll the contents of the display and move the position of the current selection; pressing the jog wheel 106 as a button can also invoke an operation in a fashion similar to pressing a button on a mouse. Selecting a name from a list of phone numbers is a pertinent example: the device user rolls the jog wheel 106 down to move the selection to a desired name. The list of names may scroll off the top of the display 103 if the name is at the bottom of the list. Once the desired name is highlighted, the user presses the jog wheel 106 to select commands for that name. A secondary screen, often a menu, may then be shown. The escape button 105 can be used to cancel the operation and go back to the previous screen. Textual input can be entered on the device 101 by using the buttons 108a and 109a of keyboard portions 108 and 109, and by using the space bar 107.

FIG. 1b is a side elevational view of the device 101 taken along line 1b-1b of FIG. 1a. The sliding cover 110 can be seen to carry keyboard portion 109. A switch 113 is closed when the sliding cover 110 is in position “C” and open when the sliding cover 110 is in position “O.” In some embodiments, a type of sensor other than a switch 113 is used to determine the position of the sliding cover 110.

In the closed position “C,” the device may be about 4.5 inches long, and in the open position “O,” the device may be about 6 inches long. The width of the device may be about 1.5 to 2 inches and the depth of the device may be about 0.5 to 1 inch. Of course, these measurements serve as examples only. It is to be understood that in various embodiments the device 101 can be other sizes, as desired.

FIG. 1c is a side elevational view of the sliding cover 110 and its portion of the keyboard 109. The slot 114 in the sliding cover 110 allows access to the escape button 105 and the jog wheel 106 of FIG. 1b when the sliding cover is in the closed position “C.”

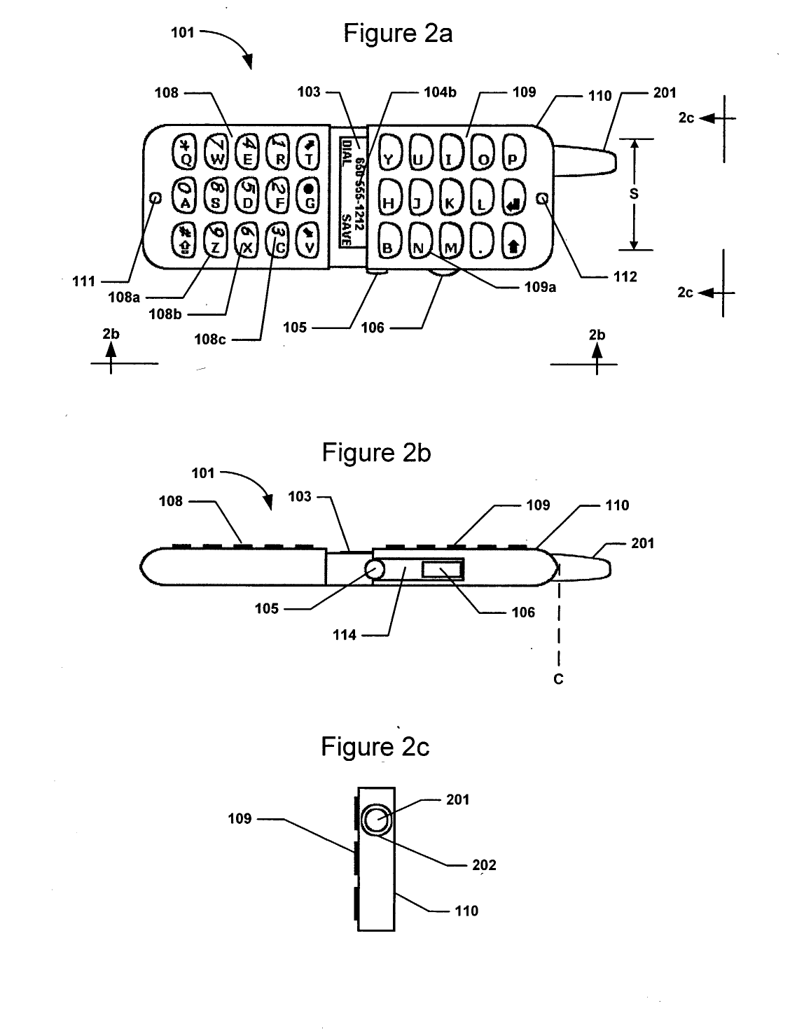

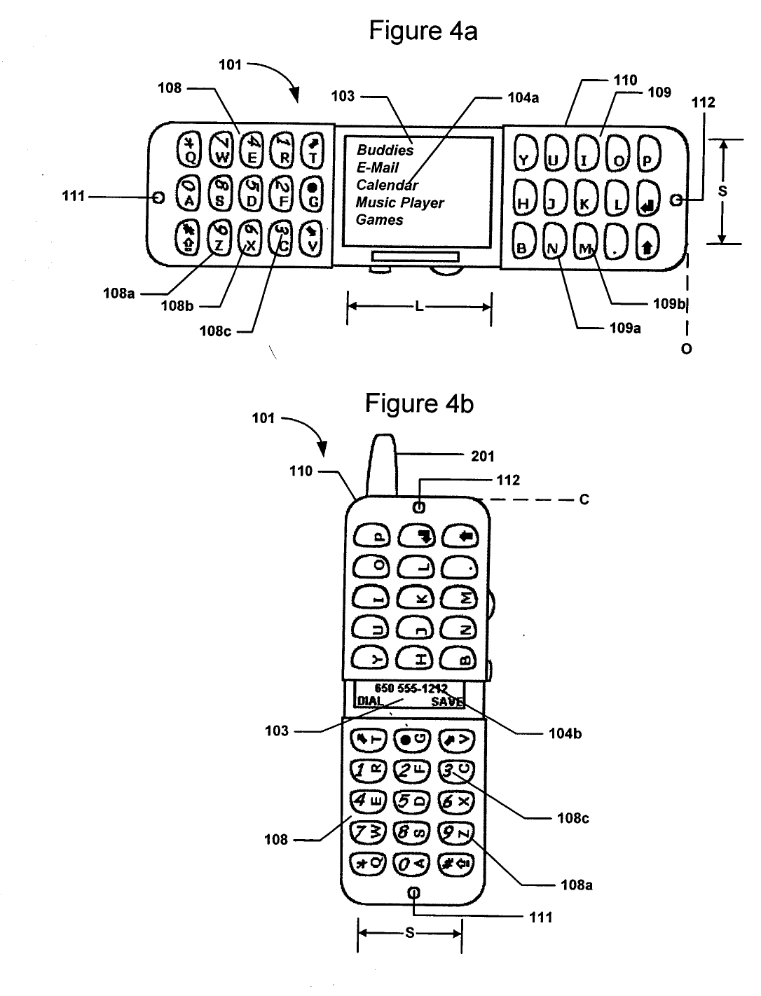

FIG. 2a is a top plan view of the device 101 in telephony input mode. It should be noted that in telephony input mode, the device of FIG. 2a is typically held vertically with the antenna 201 upwardly pointed, as seen in FIG. 4b. The sliding cover 110 is in the closed position “C,” covering the space bar 107 and most of the display 103, as seen in FIG. 1a. When the sliding cover 110 is closed, the switch 113 as seen in FIG. 1b signals to the device 101 that the device 101 is now in telephony input mode (conversely, when the sliding cover 110 is opened, the switch 113 signals to the device 101 that the device 101 is in textual input mode). An antenna 201 can be uncovered when the sliding cover 110 is in the closed position “C.” A slot 114 (shown in FIG. 2b) in the sliding cover 110 permits access to the escape button 105 and the jog wheel 106 so these elements may still be utilized to operate the device 101 in telephony input mode. The apertures for the microphone 111 and the earphone 112 for operating the device 101 as a telephone are provided. In telephony input mode, the information on the display 103 is formatted in “portrait” mode. In portrait mode, the lines of text 104b on the display 103 are parallel to the short dimension S of the display 103. Telephony input is entered on the device using the buttons 108a with telephony legends 108c located on keyboard portion 108 of the device.

FIG. 2b is a side elevational view of the device 101 taken along line 2b-2b of FIG. 2a. The slot 114 allows access to the escape button 105 and the jog wheel 106 when the sliding cover 110 is in the closed position “C.”

FIG. 2c is a side elevational view of the device 101 taken along line 2c-2c of FIG. 2a. The sliding cover 110 and its portion of the keyboard 109 are visible. The antenna 201 protrudes through an opening 202 when the sliding cover 110 is in the closed position “C.”

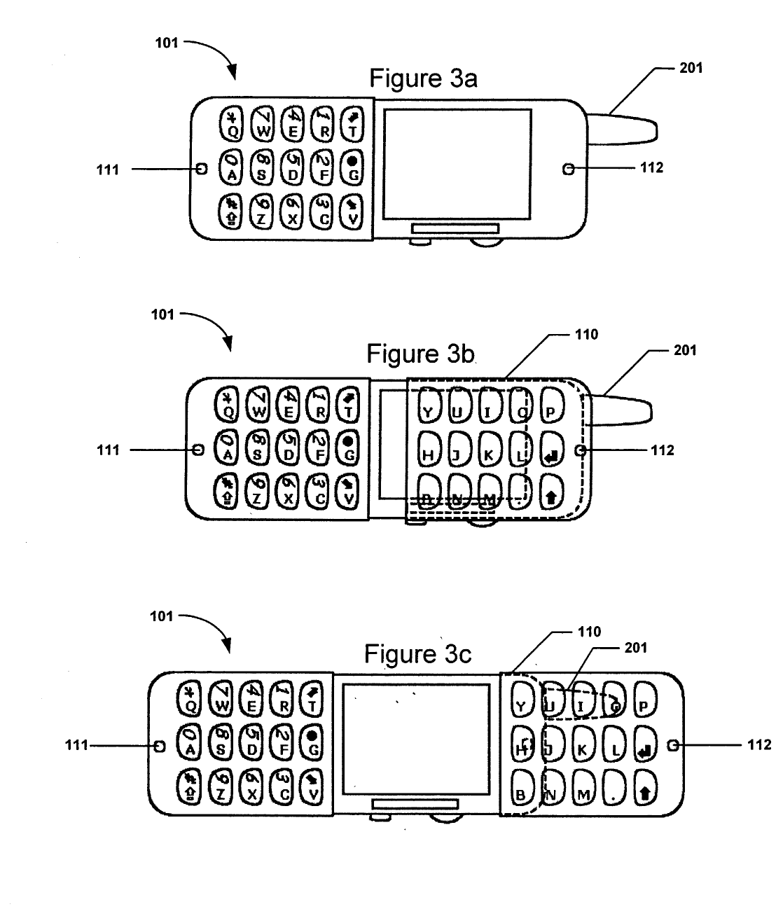

FIG. 3a is a top plan view of the device 101 similar to FIG. 2a with the sliding cover 110 removed. FIG. 3b is a top plan view of the device 101 similar to FIG. 2a with the sliding cover 110 closed, but with the hidden body 101 details illustrated. It is to be understood that the position of the closed sliding cover 110 is represented by the dotted lines. FIG. 3c is a top plan view of the device 101 similar to FIG. 1a with the hidden body details illustrated. As with FIG. 3b, the position of the closed sliding cover 110 is represented by the dotted lines. In some embodiments, the antenna 201 can provide mechanical support to the sliding cover 110 when the cover 110 is opened, as is illustrated in FIG. 3c.

FIGS. 4a and 4b show the display 103 of the device 101 in textual input mode and telephony input mode, respectively, according to one embodiment of the present invention. FIG. 4a is a top plan view of the device 101 in textual input mode. In textual input mode, the information on the display 103 is formatted in “landscape” mode. In landscape mode, the lines of text 104a on the display 103 are parallel to the long dimension L of the display 103. When the device is in textual input mode, the full display 103 can be visible, and may be utilized when the sliding cover 110 of the device is in the open position “O.” The textual legends 108b and 109b located on buttons 108a and 109a of keyboard portions 108 and 109 are also formatted in landscape mode. In landscape mode, the textual legends 108b and 109b are parallel to the long dimension L of the display 103.

To operate the device in textual input mode, the device 101 user holds the device horizontally with the sliding cover 110 open and uses the buttons 108a and 109a to enter textual input. This is similar to how a user would normally hold a portable textual communications device. Typically, a portable textual communications device user holds the device in two hands and uses one or both thumbs to enter textual input. As illustrated, the letter-number scheme of the device 101 can be different from the letter-number scheme of other simplified QWERTY keyboards. As described above, some simplified QWERY keyboards have numbers overlaid on the first row of letters. On the device 101, the textual legends 108b and 109b on buttons 108a and 109a can have a telephony legend 108c rotated ninety degrees from the textual legends 108b and 109b, and associated with that textual legend. For example, the “D” has a “ [symbol] ” printed above it. When the device user holds the device horizontally, she does not use the device for telephony input.

FIG. 4b is a top plan view of the device 101 in telephony input mode. In telephony input mode, the information on the display 103 is formatted in “portrait” mode. In portrait mode, the lines of text 104b are parallel to the short dimension S of the display 103. When the device is in telephony input mode, the sliding cover 110 is closed in position “C,” and the screen is “cropped” because most of the display 103 is hidden by the sliding cover 110. The telephony legends 108c on buttons 108a of keyboard portion 108 are also formatted in portrait mode. In portrait mode, the telephony legends 108c are parallel to the short dimension S of the display 103.

To operate the device in telephony input mode, the user holds the device 101 vertically with the sliding cover 110 closed. This is similar to how a user would normally hold a smart telephone (or any cellular telephone). Typically, a smart phone user holds the phone in one hand, and enters telephony input with the fingers of her other hand, or she holds the phone in one hand and enters telephony input with her thumb of that same hand. On the device 101, telephony legends 108c on buttons 108a have associated textual legends 108b. Each textual legend 108b is rotated ninety degrees from its associated telephony legend 108c. For example, the “5” does not have the letters “JKL” associated with it as does a cellular telephone. Rather, the “5” has a “ [symbol] ” associated with it. When the device user holds the device vertically, she does not use the device for textual input.

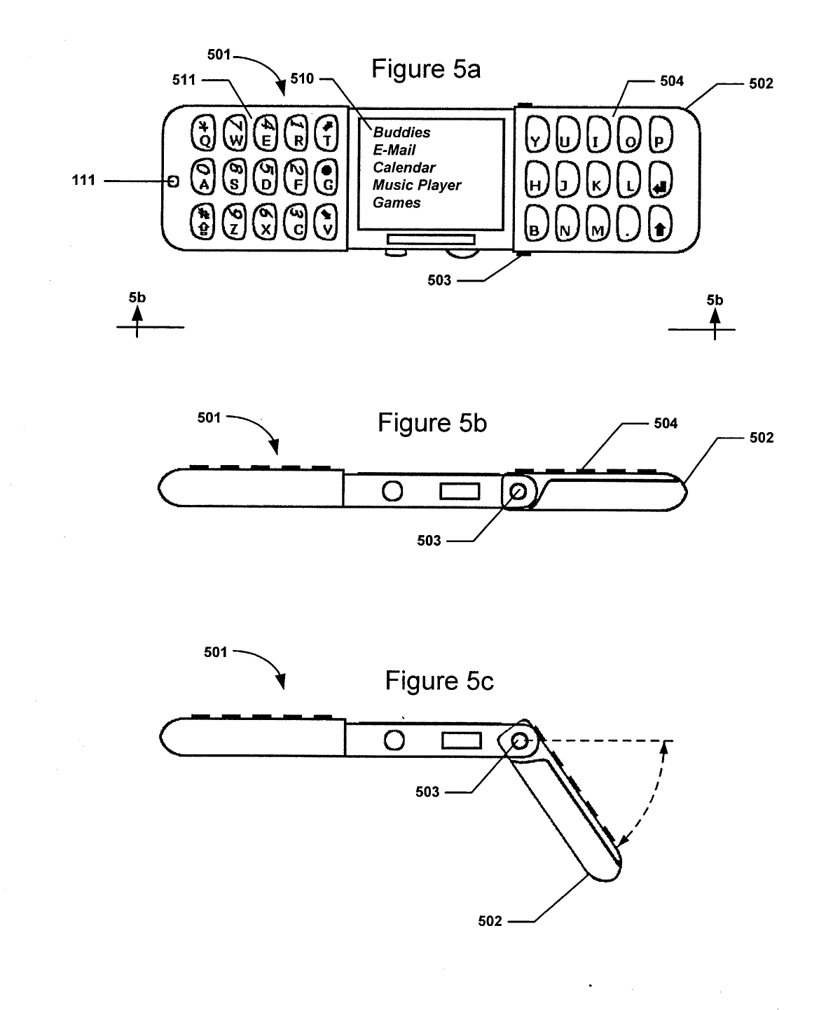

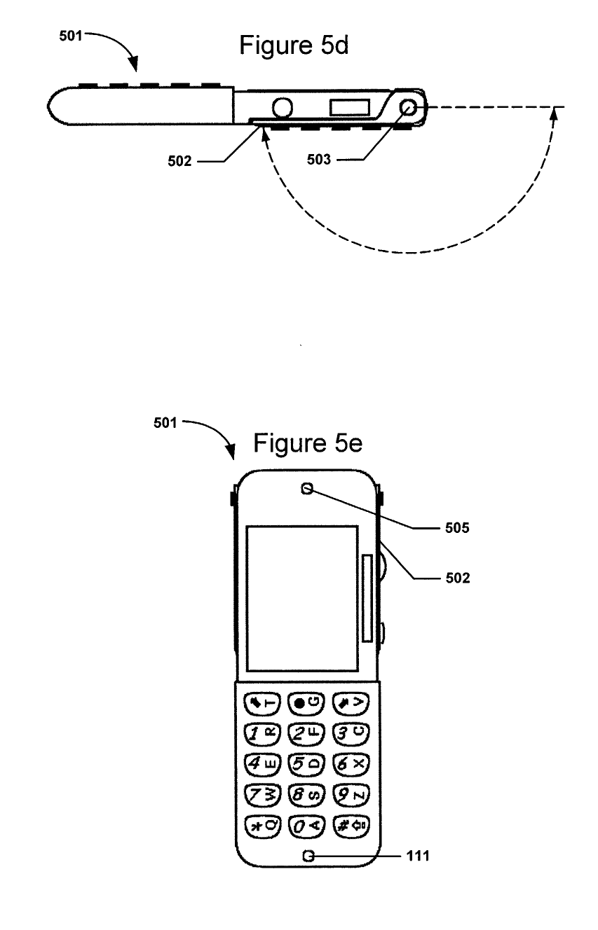

FIG. 5a is a top plan view of the device 501 in textual input mode, according to another embodiment of the invention. In place of the sliding cover 110 of the previously described embodiment, the device has a pivoting cover 502 that rotates around a pin 503. To operate the device in textual input mode, the user flips up the pivoting cover 502. When the pivoting cover 502 is flipped up, the full display 510 is available, including a simplified QWERTY keyboard, which is divided into two portions, portions 511 and 504. In textual input mode, the device of FIG. 5a looks and operates similarly to the device of FIG. 1a, as previously described.

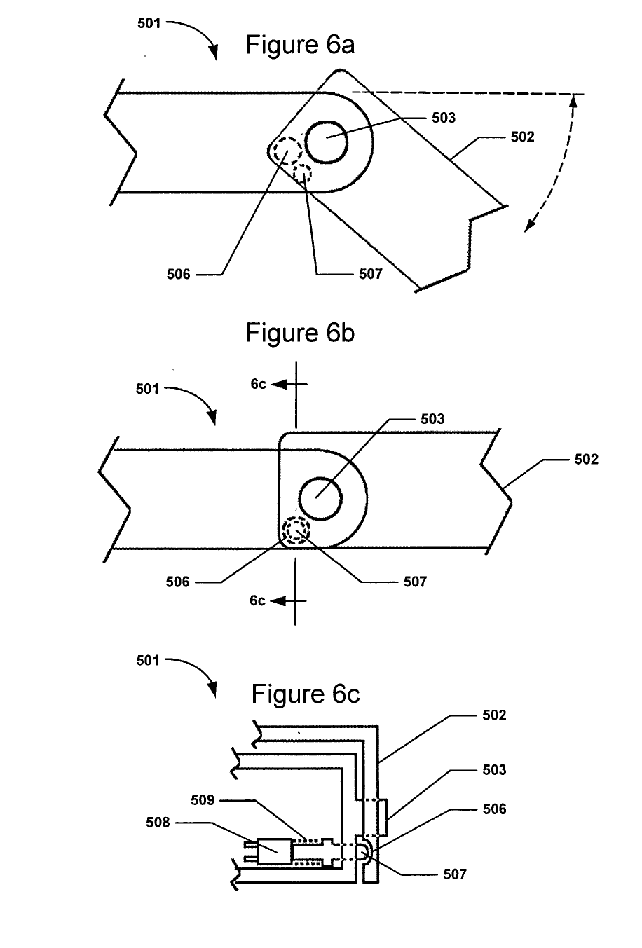

FIG. 5b is a side elevational view of the device 501 taken along line 5b-5b in FIG. 5a. Similar to the sliding cover 110 in FIG. 1b, the pivoting cover 502 is considered open as illustrated in FIG. 5b. The pivoting cover 502 can be seen to carry keyboard portion 504. A switch 508 as seen in FIG. 6c is open when the pivoting cover 502 is in position “O” and closed when the pivoting cover is in position “C” as seen in FIG. 5d. In some embodiments, a type of sensor other than a switch 508 is used to determine the position of the pivoting cover 502.

FIG. 5c is a side elevational view of the device 501 taken along line 5b-5b similar to FIG. 5b, but the pivoting cover 502 is partially closed by rotating around pin 503.

FIG. 5d is a side elevational view of the device 501 similar to FIG. 5b, but the pivoting cover 502 is in the closed position “C” after rotating around pin 503. The pivoting cover 502 now lies flat against the back of the device 501. When the pivoting cover 502 is in the closed position “C,” the switch 508 as seen in FIG. 6c signals to the device 501 that the device 501 is now in telephony input mode. Conversely, when the pivoting cover 502 is in the open position “O,” the switch 508 signals to the device 501 that the device 501 is in textual input mode.

FIG. 5e is a top plan view of the device 501 in telephony input mode, according to the embodiment of the present invention illustrated in FIG. 5a. The pivoting cover 502 is in the closed position “C” and the device 501 turned to the typical usage orientation for telephony input. The aperture for the earphone 505 of the device 501 is exposed when the pivoting cover 502 is closed. In textual input mode, the device of FIG. 5e looks and operates similarly to the device of FIG. 4b, as previously described.

FIG. 6a is an enlarged side elevational view of the pivoting area 502 from FIG. 5c of the device 501, according to one embodiment of the present invention. A portion of the device 501, the pivoting cover 502, and the pin 503 are shown. A switch actuator 507 located in the device is closed in all rotations except when it aligns with a detent 506 in the pivoting cover 502. The switch 508 as seen in FIG. 6c signals to the device whether the device is in textual input mode or telephony input mode.

FIG. 6b is a side elevational view of the device 501 similar to FIG. 6a, but the pivoting cover 502 is in the open position “O” as seen in FIG. 5b and the device is in textual input mode. The switch actuator 507 is extended because it aligns with detent 506.

FIG. 6c is a cross-sectional view of the device 501 taken along line 6c-6c in FIG. 6b. The shell of the device 501 encloses the switch mechanism comprising the switch 508, a compression spring 509, and the switch actuator 507. The pivoting cover 502 pivots around the pin 503 as seen in FIG. 6a. The detent 506 aligns with the switch actuator 507 to electrically open the switch 508. The switch actuator 507 and the detent 506 also provide a mechanical lock to help maintain the pivoting cover 502 in the open position “O” as seen in FIG. 5b.

It will be readily apparent to one of ordinary skill in the relevant art that alternative embodiments of the present invention can include variations in the keyboard, display, cover and/or switch, as desired. As will be understood by those familiar with the art, the invention may be embodied in other specific forms without departing from the spirit or essential characteristics thereof. Likewise, the particular naming and division of the components, modules, features, attributes, methodologies and other aspects are not mandatory or significant, and the mechanisms that implement the invention or its features may have different names, divisions and/or formats. Accordingly, the disclosure of the present invention is intended to be illustrative, but not limiting, of the scope of the invention, which is set forth in the following claims.

What is claimed is:

1. A communications device for receiving telephony and textual input, the communications device comprising:
a three dimensional body comprising a length, a width and a height, the length being greater than the width;
a display for providing visual output, the display comprising a length and a width, the display being coupled to the body such that the length of the display is parallel to the length of the body;
a plurality of buttons for receiving input, at least some of the buttons being labeled on a first axis as buttons of a telephone keypad and on a second axis as buttons of a textual keyboard, the first axis being parallel to the width of the body, the second axis being parallel to the length of the body, the plurality of buttons being coupled to the body;
a sensor for determining whether telephony or textual input data is to be obtained from the buttons, the sensor being communicatively coupled to the body.

2. The device of claim 1 further comprising:
a movable portion coupled to the body; and
a second plurality of buttons for receiving input, at least some of the buttons of the second plurality being labeled on an axis parallel to the length of the body as buttons of a textual keyboard, the second plurality of buttons being coupled to the moveable portion.

3. The device of claim 2 wherein the movable portion is such that:
in a first position the movable portion partially obscures the display;
in a second position the movable portion does not obscure the display; and
the device obtains telephony input from the buttons when the movable portion is in the first position, and textual input from the buttons when the movable portion is in the second position.

4. The device of claim 2 in which the moveable portion comprises a sliding cover that slides along the length of the body.

5. The device of claim 4 in which:
the sensor comprises a switch that is actuated by the sliding cover, such that the switch is closed when the sliding cover is in a first position in which the sliding cover partially obscures the display such that a visible portion of the width of the display is greater than a visible portion of the length of the display;
the switch is open when the sliding cover is in a second position in which the sliding cover does not obscure the display; and
the device obtains textual input from the buttons when the switch is open, and telephony input from the buttons when the switch is closed.

6. The device of claim 2 further comprising:
a pin coupled to the body; and in which
the moveable portion comprises a pivoting cover that rotates at least partially around the pin, the pivoting covering being hinged to the body by the pin.

7. The device of claim 6 in which:
the sensor comprises a switch that is actuated by the pivoting cover, such that the switch is closed when the pivoting cover is in a first position in which the pivoting cover partially obscures the display such that a visible portion of the width of the display is greater than a visible portion of the length of the display;
the switch is open when the pivoting cover is in a second position in which the pivoting cover does not obscure the display; and
the device obtains textual input from the buttons when the switch is open, and telephony input from the buttons when the switch is closed.

8. The device of claim 7, further comprising:
a detent within the pivoting cover; and
a switch actuator within the pivoting cover and coupled to the switch, such that the switch is closed when the pivoting cover is in all positions other than when the switch actuator is aligned with the detent, in which case the switch is open.

9. The device of claim 8, further comprising:
a switch mechanism within the pivoting cover, comprising the switch, the switch actuator, and a compression spring mounted between the switch and the switch actuator such that when the detent is aligned with the switch actuator, the switch is electronically opened; and wherein
the detent and the switch actuator form a mechanical lock to help maintain the pivoting cover in the open position.

10. The device of claim 1 in which:
data is output on the display parallel to the length of the display when textual input data is obtained from the buttons; and
data is output on the display parallel to the width of the display when telephony input data is obtained from the buttons.

11. The device of claim 1 in which:
at least some of the buttons are labeled on the axis parallel to the width of the device with the legends of a standard telephone keypad: 1, 2, 3, 4, 5, 6, 7, 8, 9, *, 0 and #.

12. The device of claim 1 in which:
at least some of the buttons are labeled on an axis parallel to the length of the device with the legends of a simplified QWERTY keyboard, in a layout that has three rows of keys.

13. The device of claim 1 further comprising:
a jog wheel, for accepting input to manipulate the visible output of the display, the jog wheel being coupled to the body.

14. The device of claim 1 in which one of the buttons comprises an escape button, for accepting input to cancel a current operation.

15. The device of claim 1 in which one of the buttons comprises a space bar.

16. A method for receiving both telephony and textual input by a single communications device comprising a three dimensional body, a display comprising a length and a width, a plurality of buttons for receiving input, a movable portion coupled to the body and a sensor for determining whether telephony or textual input data is to be obtained from the buttons, the method comprising:
receiving telephony input data from the plurality of buttons when the movable portion is in a first position in which the movable portion partially obscures the display;
receiving textual input data from the buttons when the movable portion is in a second position in which the movable portion does not obscure the display.

17. The method of claim 16, further comprising:
displaying output data on the display parallel to the length of the display when textual input data is obtained from the buttons; and
displaying output data on the display parallel to the width of the display when telephony input data is obtained from the buttons.
